(19) United States
(12) Patent Application Publication
(10) Pub. No.: US 2006/0158040 A1
(43) Pub. Date: Jul. 20, 2006

(54) Configurable electrical outlet

(76) Inventor: Jason McIntosh, Indianapolis, IN (US)

Correspondence Address: MAGINOT, MOORE & BECK, LLP;CHASE TOWER, 111 MONUMENT CIRCLE, SUITE 3250, INDIANAPOLIS, IN, 46204, US

(21) Appl. No.: 11/038,871

(22) Filed: Jan. 19, 2005

(51) Int. Cl. H02B 1/24

(52) U.S. Cl. 307/114

(57) ABSTRACT

An electrical outlet assembly includes a pair of electrical receptacles for receiving plugs of electrical devices. The outlet assembly is connected to a neutral conductor and to switched and un-switched line conductors. The outlet assembly includes its own selector switches that permit selective electrical connection of a corresponding one of the receptacles to either the switched or un-switched line conductors. The outlet assembly can be selectively configured so that both electrical receptacles are switched, both are un-switched or one is switched and the other is un-switched.

### BACKGROUND OF THE INVENTION

The present invention relates to electrical wiring systems, and more particularly to switched and un-switched outlets within building wiring systems.

In the electrical system of a residential, commercial or other type of building, electrical power is accessed through outlets dispersed along the building walls. Some of the outlets are switched, meaning that electrical current to the outlet is controlled by a wall switch or similar device. Most of the outlets in a building are un-switched, apart from the circuit breaker panel.

Building electrical systems are relatively permanent. Any change in the wiring or outlets typically requires access through the walls or ceiling of the building or, at a minimum, substitution of the outlets, electrical receptacles within the outlets or switches. Changing an outlet to and from a switched outlet is usually a significant undertaking that requires re-routing of the building wiring. In many cases, reconfiguring the building outlets is not worth the trouble, so the building occupant is resigned to simply “make do” with the existing switched and un-switched outlet arrangement.

This problem is particularly troublesome in a residential setting since the presence or absence of a switched outlet often dictates the placement of furniture, appliances and other electrical devices in a room. For example, in a bedroom it may be desirable to have a light on a switched outlet on a night stand, but it is also desirable to have an electric clock on the same night stand. Obviously placing the clock on the switched outlet is problematic, so the homeowner is forced to sacrifice the switched night stand light. Another problem arises when the homeowner wishes to rearrange the furniture layout in a room. The presence of a switched outlet often dictates where certain furniture and appliances are positioned in a room, which may mean that the available room layouts are severely limited.

Some attempts have been made to devise a configurable building electrical system that allows an occupant to determine which outlets in a room are switched. One such system is disclosed in U.S. Pat. No. 5,895,985, issued on Apr. 20, 1999. In this system, two plug-in modules are provided: a control unit that is plugged into an existing switched outlet and a companion remote switching unit that is plugged into a remote outlet receptacle where switching is desired. One obvious detriment of this system is that it requires the addition of bulky RF transmitter and receiver modules to existing outlet receptacles. These added modules are not only visually undesirable, they may also interfere with the placement of an appliance or furniture. Another detriment of the system disclosed in the '985 Patent is that only one receptacle in an outlet can be connected to a receiver module.

In another less sophisticated approach, the receptacles of an outlet are wired to a separate socket. A switch array disclosed in U.S. Pat. No. 3,928,737 is plugged into the socket to provide on-off switches for the receptacles. A long cord allows the switch array to be placed remotely from the outlet. While this approach allows conversion of both receptacles of a outlet to a switched outlet, it still requires the addition of separate modules that must be accounted for in designing a room layout.

There is an unmet need for a system that allows a building occupant to select any outlet of a room as a switched outlet. The system must be visually and physically unobtrusive. Moreover, an optimum system would not require the use of additional devices.

### SUMMARY OF THE INVENTION

These needs are fulfilled by the configurable electrical outlet of the present invention. In a preferred embodiment, each electrical receptacle of an outlet is wired to an associated selector switch. Each selector switch is connected across a switched load conductor and an un-switched load conductor of the building electrical system. Each selector switch can be actuated to connect the corresponding receptacle to either the switched or the un-switched load wire.

It is one object of the invention to provide a configurable electrical system for a building in which selected electrical outlets can be made switched or un-switched. One benefit of this invention is that it is incorporated into any existing outlet and does not require the use of any external devices. Other objects and benefits of the invention will be discerned from the following written description taken with the accompanying figures.

### DESCRIPTION OF THE FIGURES

FIG. 1 is a perspective view of a portion of a room of a building showing a typical electrical system.

FIG. 2 is a front view of an electrical outlet according to one embodiment of the invention for use in the electrical system shown in FIG. 1.

FIG. 3 is an electrical schematic of the outlet assembly illustrated in FIG. 2.

FIG. 4 is an electrical schematic of a modified switch for the outlet assembly in accordance with a further embodiment of the invention.

FIG. 5 is a perspective view of a portion of a room of a building showing the electrical outlets of the present invention integrated into the building electrical system.

### DESCRIPTION OF THE PREFERRED EMBODIMENTS

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

An electrical system for a typical building, such as a residence, is shown in FIG. 1. The electrical system includes neutral N and line L inputs from the building power meter. Several outlets O are un-switched and are connected in parallel to the neutral and line input wires. An additional outlet SO is a switched outlet that is connected to the electrical system inputs through a switch S. In particular, the switched outlet SO is connected to the neutral wire N and a switched line input SL. In the typical residential electrical system, the neutral and line inputs N and L are fed by a three-phase AC power grid; however, the present invention can be applied equally well to electrical systems connected to other forms of electrical power.

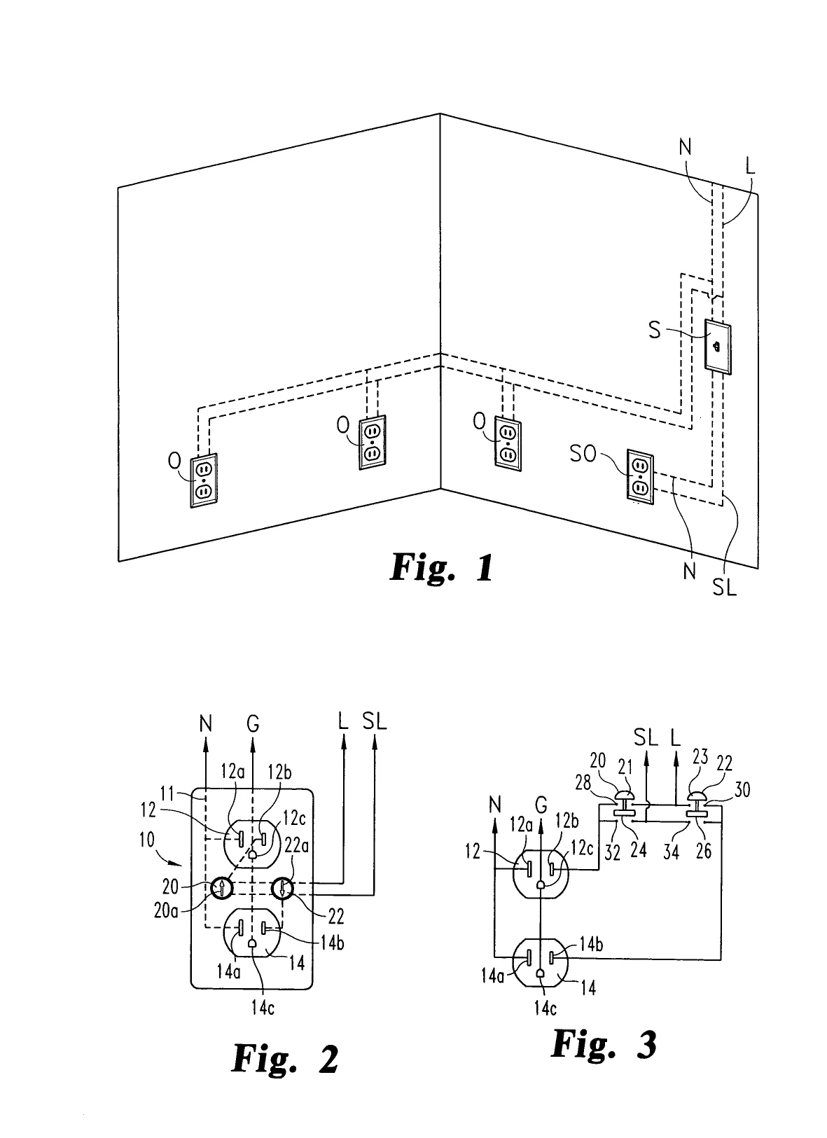

In accordance with the present invention, each of the outlets O and SO may be replaced by an outlet assembly 10 illustrated in FIGS. 2-3. The outlet assembly 10 may be of the well-known design in which two electrical receptacles 12 and 14 are supported in a common outlet box. Each receptacle 12, 14 includes electrical connections to the common neutral conductor N of the building electrical system, such as sockets 12a, 14a. (However, it is contemplated that each receptacle can have its own neutral where each receptacle is part of a separate building circuit). Each receptacle further includes an electrical connection in the form of a corresponding socket 12c connected to a ground conductor G that is preferably common to both receptacles of the outlet assembly 10.

In accordance with the typical electrical outlet, each receptacle 12, 14 includes an electrical connection to the line conductor of the electrical system through line sockets 12b, 14b to complete the electrical circuit. It is understood that receptacles as thus far described following the construction of a typical residential electrical socket and are configured to receive the prongs of a typical electrical plug. Of course, other electrical receptacle configurations may be envisioned that can be adapted to the present invention provided that the receptacle includes a line input socket or equivalent component.

In the typical electrical receptacle, each line socket 12b, 14b is connected to the line wire L of the electrical system. In accordance with the present invention, the line sockets 12b, 14b are selectively electrically connected to the line wire L or the switched line wire SL connected to the switch S. In particular, a selector switch 20 is wired between each the socket 12b and the two line wires L and SL. A similar selector switch 22 is wired to the socket 14b. Each switch 20, 22 is configured to connect the corresponding socket to either the switched line wire SL or the un-switched line wire L.

The selector switches 20, 22 can take on a variety of configurations. One preferred configuration is shown in FIG. 3 in which the switches include a contact plate 24, 26 that is moved by manipulation of the actuator button 21, 23. In one position, the contact plate 24, for example, completes the electrical circuit between leads 28 connected to the un-switched line wire L. In a second position, the contact plate 24 completes an electrical circuit between leads 32 connected to the switched line wire SL. Similar leads 30 and 34 are provided for the second selector switch 22 so that its corresponding contact plate 26 completes an electrical circuit with the un-switched line wire L or the switched line wire SL, respectively.

The selector switches 20, 22 are preferably two position switches so that the corresponding contact plate 24, 26 is necessarily in contact with one or the other of the line wires SL and L. Alternatively, the selector switches can be provided with a third position in which the electrical circuit to the associated socket 12b, 14b is broken, in which case the corresponding receptacle 12, 14 is not energized.

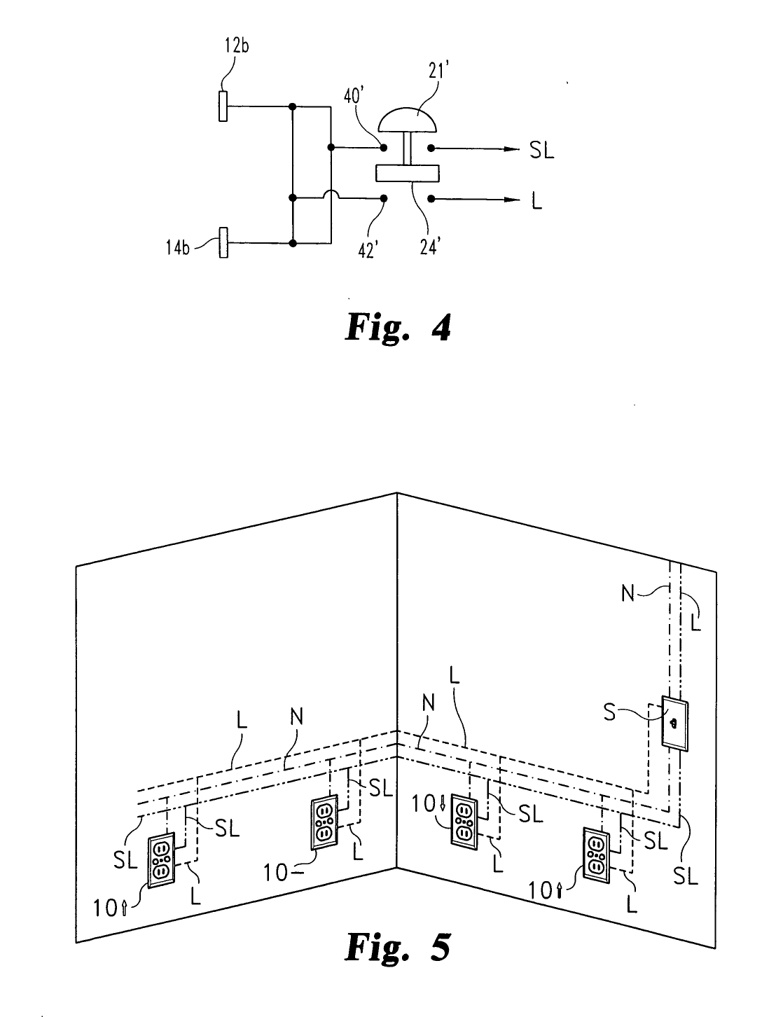

In a further alternative, both receptacles can be linked so that both receptacles are made switched or un-switched together. With this alternative, a single selector switch, such as switch 21, is integrated into the outlet assembly. Furthermore, the leads 30 and 34 shown in FIG. 3 are eliminated in favor of a direct wire connection to the receptacle 14. Thus a selector switch 20′ can be wired between the switched and un-switched line wires SL and L as shown in FIG. 4. In this embodiment, the receptacle sockets 12b and 14b are wired in parallel and leads 40′ and 42′ are interposed in the switched line wire SL and un-switched line wire L, respectively. The selector switch 21′ includes a contact plate 24′ that is movable between one position in which it completes the circuit between leads 40′ and a second position in which it completes the circuit between leads 42′. With this alternative, both sockets 12b and 14b will be switched when the contact plate 24′ connects the receptacle wiring to the input switched line wire SL.

Preferably, the selector switches are two position push-button switches that may be depressed to render the receptacle a switched receptacle and released to return the receptacle to an un-switched configuration. The push-button switches are preferably configured to hold the depressed and released positions until the switch is depressed. As shown in FIG. 2, the two selector switches 20, 22 may include appropriate indicia indicating which electrical receptacle 12, 14 is controlled by which switch. Thus, the arrow 20a is pointed to the upper receptacle 12 indicating that when selector switch 20 is depressed the upper receptacle becomes a switched receptacle. The same protocol is followed with respect to the arrow 22a on the selector switch 22 relative to the lower receptacle 14.

The selector switches 20, 22 and the corresponding contact plates 24, 26 can have other configurations that can be manually operated to complete the circuit between leads 28 or 32, for the upper receptacle 12, or between leads 30, 34 for the lower receptacle 14. For instance, the selector switches may be rotary two-position switches so that the switch is rotated between two positions. The contact plates and corresponding leads for the switched and un-switched line wires SL and L are modified as is known in the art to complete the circuit between the proper leads when rotated from one position to the other. Similarly, the selector switches may be toggle switches, again with appropriate modification to the contact plates 24, 26 and the leads 28, 30, 32 and 34.

In the preferred embodiment, the selector switches 20 and 22 are integrated into the switch plate 11 for the outlet assembly 10. Consequently, the switches 20, 22 and associated wiring are compact to fit within the outlet envelope. The outlet assembly 10 is thus readily substituted into existing building wiring. It is understood that the un-switched load line L and switched load line SL must be wired to every outlet location that is intended to incorporate the outlet assembly 10 of the present invention. In a residential building, one option may be to provide a switchable outlet assembly 10 on each wall of a room, such as a bedroom. Alternatively, every outlet in a particular room can include the outlet assembly 10. In either case, the resident can select which of the outlets, or more specifically which receptacles of the outlets, is made switched. This feature provides the resident with a great degree of flexibility in the placement of electrical devices and accessories within the room.

As suggested by the electrical layout shown in FIG. 5, the outlet assembly 10 of the present invention can link each receptacle to a single wall switch S. As illustrated, the switched and un-switched load lines SL, L are continued to each outlet 10 that includes the inventive capabilities. The outlets 10↑ correspond to outlets in which the selector switch 20a has been depressed to render the upper receptacle 12 a switched outlet. The lower receptacle 14 on these outlets 10↑ remains un-switched. Similarly, the outlets 10↓ correspond to outlets in which the other selector switch 20b has been activated to make the lower receptacle 14 switched. As shown in FIG. 5, the outlet 10—indicates that neither selector switch is depressed, so neither receptacle of the outlet is switched. Alternatively, selected combinations of outlets can be wired to a different wall switch (not shown). The outlets in these other combinations may then be made switched or un-switched as described above, again providing great flexibility to the occupant of the room.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed is:

1. An outlet assembly for connection to an electrical system of a building, the electrical system having a neutral conductor, a switched line conductor and an un-switched line conductor, the outlet assembly comprising:
at least one electrical receptacle configured to receive a plug of an electrical device and having a neutral connection for connection to a neutral conductor of the electrical system and a line connection for connection to a line conductor of the electrical system; and
at least one selector switch electrically connected to said line connection of said at least one electrical receptacle and having an electrical contact selectively electrically connectable between said line connection and either the switched line conductor and the un-switched line conductor.

2. The outlet assembly of claim 1, wherein:
said at least one electrical receptacle includes two electrical receptacles; and
said at least one selector switch includes a selector switch electrically connected to said line connection of each of said two electrical receptacles.

3. The outlet assembly of claim 2, wherein each selector switch includes an indicia indicating which of said two electrical receptacles is electrically connected to the selector switch.

4. The outlet assembly of claim 1, wherein said selector switch is a two-position switch.

5. The outlet assembly of claim 4, wherein said selector switch is a push-button switch.

6. The outlet assembly of claim 1, further comprising a switch plate, wherein said at least one selector switch is supported on said switch plate.

7. An electrical system for a room comprising:
a line conductor connected to an electrical source;
an un-switched line conductor connected to said line conductor;
a switched line conductor connected to said line conductor through a switch;
a plurality of electrical outlets within the room, at least one of said outlets including at least one selector switch electrically connected between at least one receptacle thereof and said un-switched and switched line conductors, said at least one selector switch operable to selectively electrically connect said at least one receptacle to either said un-switched line conductor or said switched line conductor.

8. The electrical system of claim 7, wherein said at least one of said outlets includes two receptacles and two selector switches, one each connected to one each of said two receptacles.

9. The electrical system of claim 7, wherein each of said plurality of electrical outlets includes said at least one selector switch.

10. The electrical system of claim 7, wherein said at least one selector switch is a two-position switch movable to a first position to electrically connect said at least one receptacle to said switched line conductor and to a second position to electrically connect said at least one receptacle to said un-switched line conductor.
